(19) United States
(12) Patent Application Publication
(10) Pub. No.: US 2025/0068747 A1
(43) Pub. Date: Feb. 27, 2025

(54) METHOD AND APPARATUS FOR SECURING SENSOR DATA

(71) Applicant: Samsung Electronics Co., Ltd., Suwon-si (KR)

(72) Inventors: Vipul GUPTA, Bangalore (IN); Ankur Agrawal, Bangalore (IN); Vaibhav Negi, Bangalore (IN)

(21) Appl. No.: 18/946,077

(22) Filed: Nov. 13, 2024

Related U.S. Application Data
(63) Continuation of application No. PCT/KR2022/011948, filed on Aug. 10, 2022.

(30) Foreign Application Priority Data
Jun. 10, 2022 (IN) 202241033507

(51) Int. Cl. G06F 21/60; G06N 5/04

(52) U.S. Cl. CPC G06F 21/602; G06N 5/04

(57) ABSTRACT

A method, an electronic device and a non-transitory computer readable medium for securing sensor data are provided. The method comprises: obtaining context information by fetching a plurality of sensor data by a plurality of applications, mapping the plurality of sensor data to the plurality of applications and storing the mapped plurality of sensor data, generating pre-processed information based on the context information and the mapped plurality of sensor data, creating an inference category of the pre-processed information based on the pre-processed information and information from a database, and predicting at least one useful inference and at least one harmful inference of the plurality of sensor data based on the inference category, the context information and the plurality of sensor data.

### CROSS-REFERENCE TO RELATED APPLICATIONS

This application is a continuation of International Application No. PCT/KR2022/011948 designating the United States, filed on Aug. 10, 2022, in the Korean Intellectual Property Receiving Office, and claiming priority to Indian Patent Application No. 202241033507, filed on Jun. 10, 2022, in the Indian Patent Office, the disclosures of each of which are incorporated by reference herein in their entireties.

### BACKGROUND

### Field

The disclosure relates to a method and an apparatus for securing sensor data using machine learning to create an Artificially Intelligent (AI) engine.

### Description of Related Art

With the vast increase in intelligent machines, even insignificant data has become significantly important to judge or predict various aspects of the user such as useful data and harmful data. This has led to the increase in Sensor Data misuse and privacy violations. Further, sharing sensor data could lead to inadequate access control and lack of security.

In today's world, smartphones are not merely communication devices but also sensing platforms from which a large number of applications gain continuous and unobtrusive collection of sensor data. These applications collect the sensor data on the pretext of providing a more personalized experience for the user by drawing inferences about user's personal, social, and even physiological information. But some applications are not trustworthy enough to gather so much information about the user. For instance, onboard sensors like accelerometer, gyroscope etc., does not require user permission. Studies have revealed that the accelerometer and gyroscope combined data can be used to infer large amount of information about the user. Furthermore, security ratings of the applications on play store are static in nature and does not vary on the user's behavior/requirement. Thus, the user could not make a decision about downloading or not downloading an app.

Moreover, when a user is asked to provide access to a particular sensor, the user is generally unaware of the inferences that can be drawn from that sensor or when combined with other sensor data. This perception is bound to change when the user is made aware of the harmful inferences that can be drawn. The user may either grant access or avoid using application. No provision for user to modify or revoke the access restriction during runtime is provided in the current state of the art.

Hence, there exists a need for an intelligent method and a system for securing sensor data in a manner in which useful inference of the sensor data is made by the application thereby eliminating the possibility of arriving at harmful inferences.

### SUMMARY

Embodiments of the disclosure provide an intelligent method and an electronic device for securing sensor data to prevent and/or reduce unwanted inferences from the sensor data that is being shared by the user from a hand-held device to various applications.

According to an example embodiment of the present disclosure, a method for securing sensor data is provided. The method may comprise: obtaining context information by fetching a plurality of sensor data by a plurality of applications; mapping the plurality of sensor data to the plurality of applications and storing the mapped plurality of sensor data; generating a pre-processed information based on the context information and the mapped plurality of sensor data; creating an inference category of the pre-processed information based on the pre-processed information and information from a database; and predicting at least one useful inference and at least one harmful inference of the plurality of sensor data based on the inference category, the context information and the plurality of sensor data.

According to an example embodiment of the present disclosure, an electronic device for securing sensor data is provided. The electronic device comprises a memory; and at least one processor, comprising processing circuitry, coupled to the memory. The instructions, when executed by the at least one processor, individually and/or collectively, may cause the electronic device to: obtain context information by fetching a plurality of sensor data by a plurality of applications; map the plurality of sensor data to the plurality of applications and store the mapped plurality of sensor data; generate pre-processed information base on the context information and the mapped plurality of sensor data; create an inference category of the pre-processed information based on the pre-processed information and information from a database; and predict at least one useful inference and at least one harmful inference of the plurality of sensor data based on the inference category, the context information and the plurality of sensor data.

According to an example embodiment of the present disclosure, a non-transitory computer-readable storage medium storing instructions for securing sensor data is provided. The instructions, when executed by at least one processor of an electronic device, individually and/or collectively, cause the electronic device to perform operations. The operations may comprise: mapping the plurality of sensor data to the plurality of applications and storing the mapped plurality of sensor data; generating pre-processed information based on the context information and the mapped plurality of sensor data; creating an inference category of the pre-processed information based on the pre-processed information and information from a database; and predicting at least one useful inference and at least one harmful inference of the plurality of sensor data based on the inference category, the context information and the plurality of sensor data.

In an example embodiment, an intelligent method for securing sensor data is provided. The method comprises: obtaining a context information by fetching a plurality of sensor data by a plurality of applications and mapping the obtained sensor data to the plurality of applications, wherein the mapped sensor data is then stored in a database; pre-processed information is generated by feeding the context information and the mapped plurality of sensor data into an Inference Engine Input Unit comprising circuitry; the pre-processed information and an information from a database are utilized for creating an inference category; and the information from the database includes known set of sensor data required with the inference category. Furthermore, useful inferences and harmful inferences are predicted from the sensor data collected by the plurality of applications by feeding the inputs such as inference category predicted by the personalized Inference Detection Unit, the context information from the Context Observer Unit and the plurality of sensor data fetched by the plurality of applications from the Sensor Data Monitoring Unit into a Personalized Intent Importance Unit.

Thus, the disclosure provides an intelligent method and a system for securing sensor data, which learns from the user action on the phone and playstore data and analyses the current context of the user to predict which inferences about the user could be made from the current set of sensor data whose access is provided to the application. Furthermore, the machine learning unit the Personalized Inference Detection Unit analyses of the risk of the task that the user wishes to perform from an application by measuring the importance parameter of the task in the current context against the risk inferred from all the probable information leak predicted by the previous engine. Therefore, the implementation disclosed herein encrypts the plurality of sensor data in such a way that the useful inference of the plurality of sensor data could be made by the plurality of application and the harmful inferences could not be used.

In addition, the disclosure takes user's personal aspect into consideration to judge on the basis of probable inferred information and about the user, whether the sharing of plurality of sensor data is risky or not. The disclosure not only considers the physical activity of the user and includes Artificial Intelligence to predict user's intent with the application and allows all the plurality of sensor data with intelligent encryption to be usable only for predicted user's intent. Furthermore, the combination of sensor data requested and warns the user about the consequences/inferences that could possibly be drawn from the data shared. Thus, making user more aware about the consequences of his/her actions. The disclosure also intelligently encrypts complete/partial data based on a user's intended actions from that data. Moreover, the encryption of the plurality of sensor data is personalized depending on the context, same plurality of sensor data can be harmful inference or useful inference. Hence, the encryption is dynamic in nature.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements. Further, the above and other aspects, features and advantages of certain embodiments of the present disclosure will be more apparent from the following detailed description, taken in conjunction with the accompanying drawings, in which:

FIG. 1 is a flowchart illustrating an example intelligent method for securing sensor data, according to various embodiments;

FIG. 2 is a diagram illustrating an example configuration of an intelligent system for securing sensor data, according to various embodiments;

FIG. 3 is a diagram illustrating an example Context Observer Unit, according to various embodiments;

FIG. 4 is a diagram illustrating an example Personalized Inference Detection Unit, according to various embodiments;

FIGS. 5A and 5B include a block diagram and machine learning model of Personalized Intent Importance Unit, according to various embodiments;

FIG. 6 is a table illustrating risk factor of application calculated based on user intent weightage and predicted inference weightage by the Personal Intent Importance Unit, according to various embodiments;

FIG. 7 is a block diagram illustrating an example configuration of a Sensor Data Modifier Unit, according to various embodiments;

FIG. 8 is a diagram illustrating types of sensor data combinations in a Sensor Data Modifier, according to various embodiments;

FIGS. 9A and 9B are diagrams illustrating examples of screenshots of inputs from multiple different sensors to predict useful inference and harmful inference, according to various embodiments;

FIG. 10A is a diagram illustrating a screenshot of inputs from a single sensor to predict useful inference and harmful inference, according to various embodiments;

FIG. 10B is a diagram illustrating an example of intelligently encrypting sensor data pitch, according to various embodiments;

FIG. 11 is a table illustrating various sensor combinations and useful and harmful inferences, according to various embodiments; and

FIG. 12 is a block diagram illustrating an example configuration of an electronic device, according to various embodiments.

### DETAILED DESCRIPTION

Reference will now be made in detail to the description of the present subject matter, one or more examples of which are shown in various figures. Each example is provided to explain the subject matter and not a limitation. Various changes and modifications will be apparent to one skilled in the art to which the disclosure pertains are deemed to be within the spirit, scope and contemplation of the disclosure.

The various embodiments of the disclosure provide an intelligent method and a system for securing sensor data, to prevent and/or reduce unwanted inferences from the sensor data that is being shared by the user from a hand-held device to various applications.

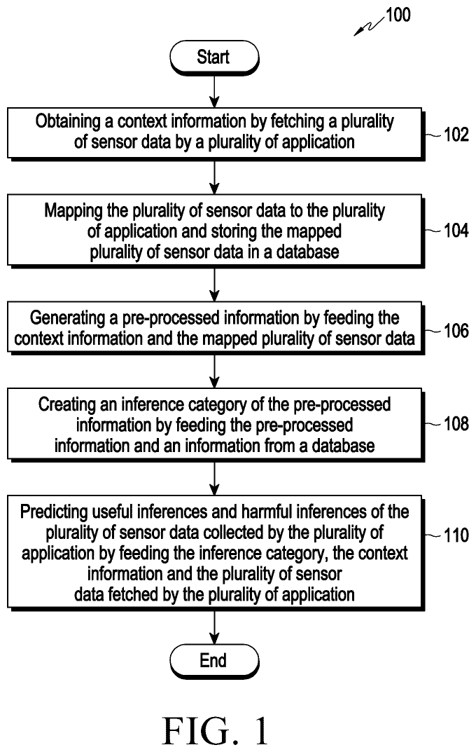

FIG. 1 is a flowchart illustrating an example of an intelligent method for securing sensor data, according to various embodiments. FIG. 1 illustrates an intelligent method (100) for securing sensor data. The method (100) may include, for example, obtaining a context information by fetching a plurality of sensor data by a plurality of application at step (102). In step (104) the sensor data is mapped to the plurality of applications and storing the mapped plurality of sensor data in a database at step (104). The method (100) generates pre-processed information by feeding the context information and the mapped plurality of sensor data at step (106). The method (100) includes creating an inference category of the pre-processed information by feeding the pre-processed information and an information from a database at step (108). The method (100) includes predicting useful inferences and harmful inferences of the plurality of sensor data collected by the plurality of application by feeding the inference category, the context information and the plurality of sensor data fetched by the plurality of application at step (110).

In an embodiment, the information from the database includes known set of the plurality of sensor data required with the inference category. The method (100) may include encrypting or modifying the entire or dynamically selective portion of the plurality of sensor data on the basis of the inference category, and utilizing and feeding the encrypted or modified plurality of sensor data. In addition, encrypting or modifying the entire or a dynamically selective portion of the plurality of sensor data on the basis of the inference category may be executed by feeding the useful and harmful inferences, in conjunction with the plurality of sensor data.

In an embodiment, encrypting or modifying the entire or dynamically selective portion of the plurality of sensor data on the basis of inference category may include the steps of atomically abstracting various sub portions of datatype of the plurality of sensor data, identifying the portion of the plurality of sensor sub-data mapped for various inferences and encrypting or modifying the plurality of sensor data, in such a way that the useful inferences of the plurality of sensor data is made used by the plurality of applications and the harmful inferences are not made.

In an embodiment, the utilization of the encrypted or modified plurality of sensor data may be carried out in such a way that the useful inference of the plurality of sensor data is used by the plurality of applications and harmful inferences are not made. Furthermore, the feeding of the encrypted or modified plurality of sensor data may implemented into the plurality of applications of a hand-held device and the hand-held device may a smartphone, mobile phone, cellular phone and the like, but is not limited thereto.

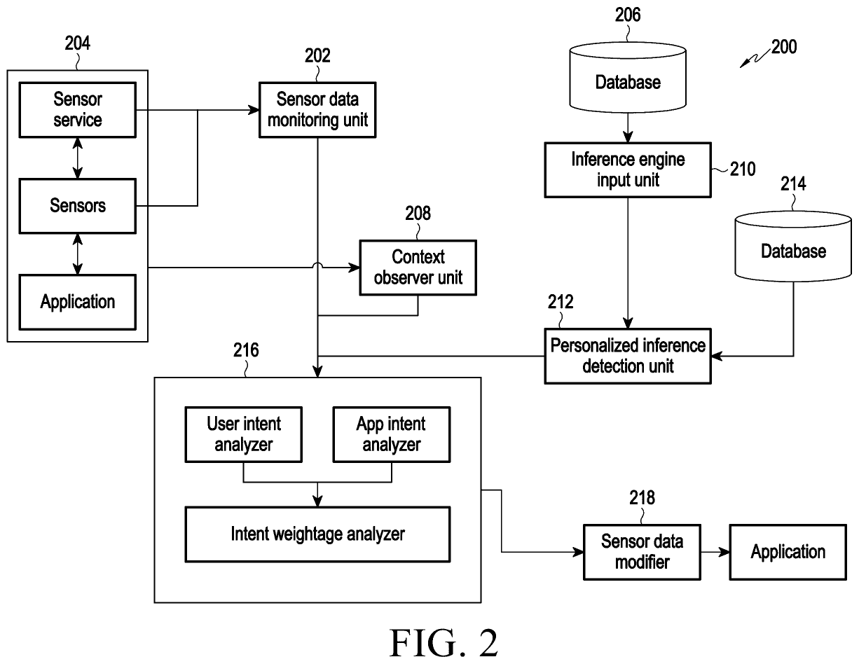

FIG. 2 is a diagram illustrating an example configuration of an intelligent system for securing sensor data, according to various embodiments. The system (200) may include a Context Observer Unit (208) configured to capture a context information when a request is made by a plurality of applications installed in a hand-held device (204) to gather a plurality of sensor data and mapping the plurality of sensor data to the plurality of application through a Sensor Data Monitoring Unit (202). The hand-held device (204) may include, for example, and without limitation, a smartphone, mobile phone or a cellular phone. The system (200) includes a database (206) configured to store the mapped plurality of sensor data. The system (200) may also include an Inference Engine Input Unit (210) configured to generate a pre-processed information by feeding the context information and the mapped plurality of sensor data. Furthermore, the system (200) may include a Personalized Inference Detection Unit (212) configured to create an inference category of the pre-processed information by feeding the pre-processed information and an information from a database (214). In addition, the system may include a Personalized Intent Importance Unit (216) configured to predict useful inferences and harmful inferences of the plurality of sensor data collected by the plurality of application by feeding the inference category, the context information and the plurality of sensor data fetched by the plurality of application. Each of the “units” described above may include various circuitry (e.g., processing circuitry) and/or executable program instructions.

Furthermore, the system (200) may further include a Sensor Data Modifier Unit (218) configured for encrypting or modifying the entire or dynamically selective portion of the plurality of sensor data on the basis of the inference category, and utilizing and feeding the encrypted or modified plurality of sensor data. The Sensor Data Modifier Unit (218) may include a sensor data atomic abstraction unit, a data-subunit-intent mapping unit and a selective subunit encryption unit. The sensor data atomic abstraction unit is configured to atomically abstract sub portions of the plurality of sensor data. The data subunit-intent mapping unit is configured to identify the portion of the plurality of sensor sub-data mapped for various inferences and the selective subunit encryption unit is configured to encrypt or modify the plurality of sensor data in such a way that the useful inferences of the plurality of sensor data is made by the plurality of application and the harmful inferences are not made. As noted above, each of the “units” or “subunits” described above may include various circuitry and/or executable program instructions.

In an embodiment, the Sensor Data Monitoring Unit (202) may be configured to monitor and store interactions between the plurality of applications and the plurality of sensor data installed in the hand-held device (204). The interactions between the plurality of applications and the plurality of sensors are mapped and stored in a database for creating user behaviour learning data. The Sensor Data Monitoring Unit (202) acts as an interface between the plurality of application installed on the hand-held device and the plurality of sensors.

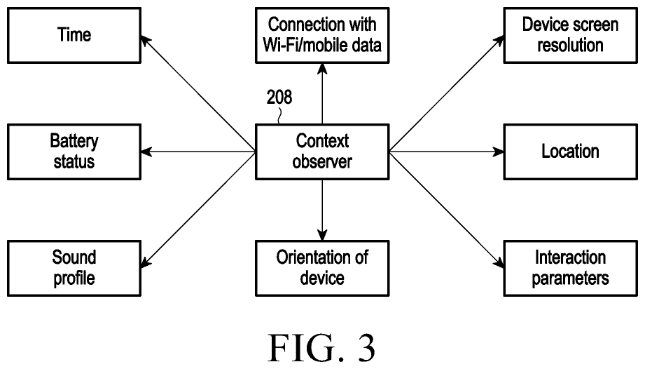

FIG. 3 is a diagram illustrating an example of the Context Observer Unit (208), according to various embodiments. The Context Observer Unit (e.g., including various circuitry and/or executable program instructions) (208) provides user-behavioural pattern with accuracy and parameters, wherein the parameters of the user behavioural pattern include Wi-Fi, network, sound, time, device screen resolution, battery status and location. Furthermore, the Context Observer Unit (208) is activated at the time when any request is made to any plurality of sensors for gathering data by any plurality of applications.

In an embodiment, the Inference Engine Input Unit (210) helps in collecting the data from the Context Observer Unit (208) and the Sensor Data Monitoring Unit (202) to process the data in the format for feeding the data into the learning engine like personalized inference detection unit while learning, and feeds the data to the personalized inference detection at the time of application.

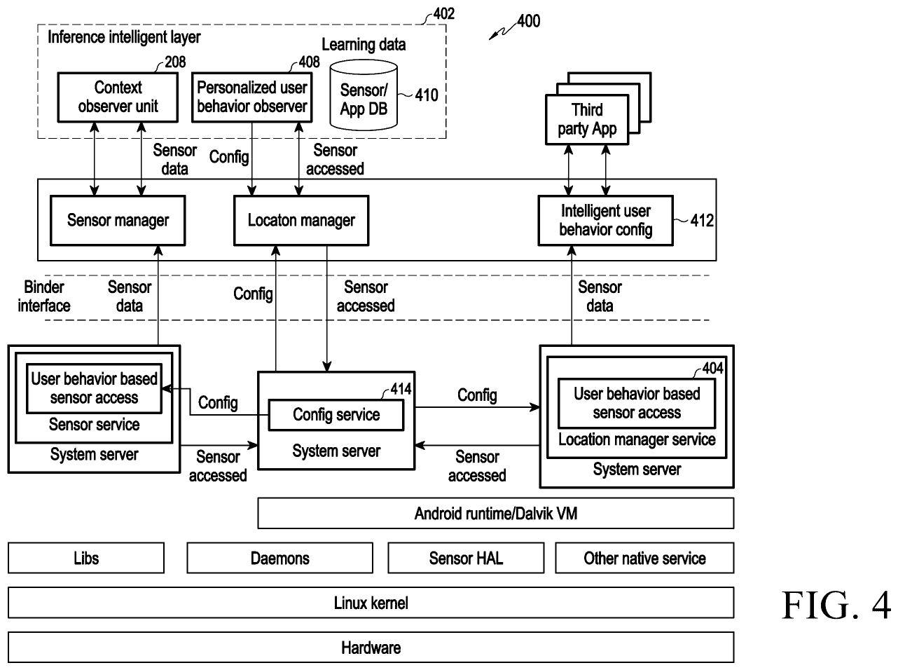

FIG. 4 is a diagram illustrating an example configuration of a Personalized Inference Detection Unit, according to various embodiments, wherein the Personalized Inference Detection Unit (e.g., including various circuitry and/or executable program instructions) (400) comprises an Inference Intelligent Layer (402) coupled to a framework layer of an operating system (404) of the hand-held device (204). The Inference Intelligent Layer (402) comprises the Context Observer Unit (208), a Personalized User Behavior Observer (408) and a database (410). The Context Observer Unit (208) is configured to observe the context data; and the Personalized User Behavior Observer (408) is configured to observe the user behavior and collect related data to adjudge the user's behavior at runtime. Furthermore, the database (410) comprises learned data, including the plurality of sensor and the plurality of application mapping for useful and harmful inferences. In addition, the framework layer of an operating system (404) of the hand-held device (204) comprises an Intelligent User Behavior Configuration module (412) and a Configuration service (414). The Intelligent User Behavior Configuration module (412) is configured to manage the user behavior configuration at runtime and the Configuration service (414) is configured to control the plurality of sensor data shared on the basis of the user behavior configuration.

In an embodiment, the Personalized Inference Detection Unit (212) is configured to receive the pre-processed information from the Inference Engine Input Unit (210) and an information from a database (214) to learn about various combination of the plurality of sensors, to depict the information about a user and the user behaviour, and to predict inference category about the user. The information from the database includes known set of the plurality of sensor data required with inference category. In addition, the database (214) comprises generic data pertaining to the application store description, purpose of the applications and data pertaining to the sensors which are being used by the applications. Furthermore, the Personalized Inference Detection Unit (212) takes the generic input from various models implemented to predict various user behaviours and user's personal data with higher weightage is added to the various user behaviours to improve the output correctness for the user. Furthermore, the output of the Personalized Inference Detection Unit (212) is various categories of inferences, that are inferred using combination of various context information and sensor information. Thus, making the user aware about the consequences of the value data being compromised from the user end.

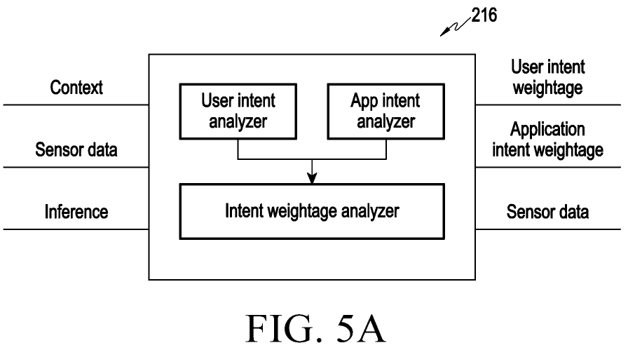

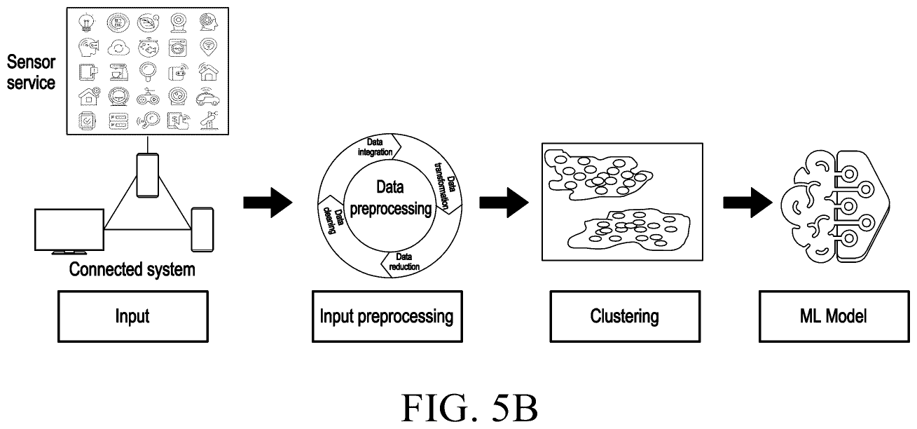

FIGS. 5A and 5B include a block diagram and a diagram illustrating an example machine learning model of Personalized Intent Importance Unit (216), according to various embodiments. FIG. 5A illustrates the Personalized Intent Importance Unit (e.g., including various circuitry and/or executable program instructions) (216) which is configured to receive input from the Context Observer Unit (208), the Personalized Inference Detection Unit (212) and the Sensor Data Monitoring Unit (202) to predict the intent of plurality of application are useful and harmful inferences. The useful and harmful inferences are derived based on the plurality of sensor data collected by the plurality of application.

FIG. 5B is a diagram illustrating an example machine learning model of the Personalized Intent Importance Unit according to various embodiments. The machine learning model comprises a connected system which collects all the information and the activities or tasks from the hand-held device and the collected data is fed into the Personalized Intent Importance Unit (216). The collected data is then pre-processed and the pre-processed data is then clustered using Machine Learning algorithm. While clustering whenever an inference category is detected by the Personalized inference detection unit (212) the importance of the inference risk against the task assigned to the plurality of application by the user is analysed and the risk factor is adjudged for the user. Finally, the generated model detects the risk of losing data for the particular user.

Furthermore, the useful inferences and harmful inferences in the Personalized Intent Importance Unit (216) is predicted by: analyzing the current context of the user's phone-usage to predict the user usage intent of the particular application; and based on the plurality of sensor data accessed during current usage predicting other probable inferences. In addition, the steps include analyzing all the probable task for importance weight to the particular user and calculating the risk involved for the user based on importance parameter for executing the user's intended task.

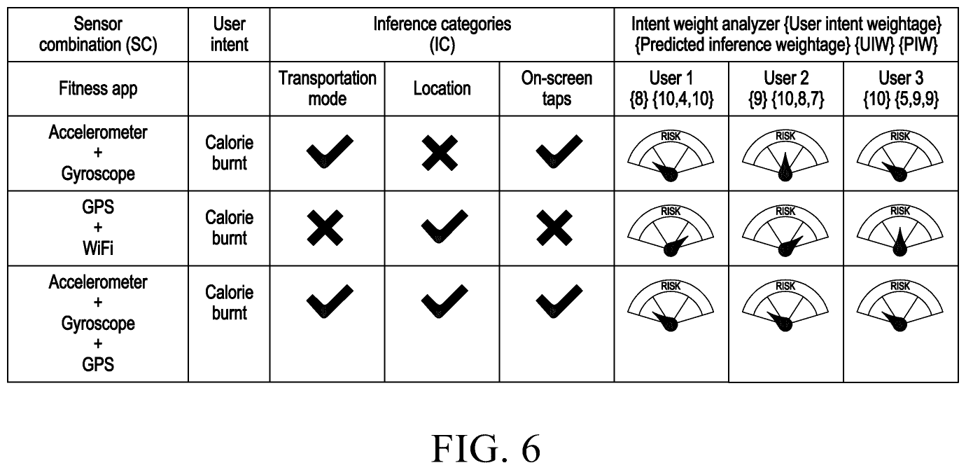

FIG. 6 is a table illustrating examples of risk factor of the application calculated based on user intent weight and predicted inference weightage by the Personal Intent Importance Unit 216, according to various embodiments. FIG. 6 is a table including a sensor combination indicating the group of sensors which are used for a particular application. For example: Fitness App 1 uses Accelerometer and Gyroscope, Fitness App 2 uses Global Positioning System (GPS) and Wi Fi sensor data and Fitness App 3 uses Accelerometer, Gyroscope and GPS. The table further includes user intent depicting type of task, a particular user intends to perform with a particular application. The inference categories indicate whether a particular inference can be predicted using the combination of sensors or not such as location, on-screen taps, transportation mode. Furthermore, the intent weight analyzer indicates the risk factor of application for a user, based on user intent weightage and predicted inference weightage.

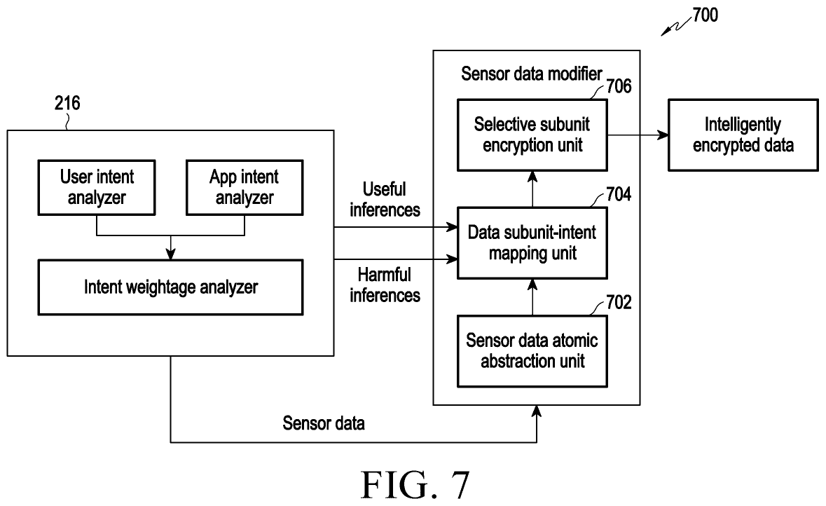

FIG. 7 is a block diagram illustrating an example configuration of a Sensor Data Modifier Unit (700), according to various embodiments. The Sensor Data Modifier Unit (e.g., including various circuitry and/or executable program instructions) (700) identifies the plurality of sensor data that is used to formulate useful and harmful inference respectively. The Sensor Data Modifier Unit (700) may also modify the plurality of sensor data intelligently such that the plurality of sensor data are not used for harmful inferences. The Sensor Data Modifier (700) comprises a sensor data atomic abstraction unit (e.g., including various circuitry and/or executable program instructions) (702), a data subunit-intent mapping unit (e.g., including various circuitry and/or executable program instructions) (704) and a selective subunit encryption unit (e.g., including various circuitry and/or executable program instructions) (706); The sensor data atomic abstraction unit (702) is configured to atomically abstract sub portions of the sensor data. The Data-subunit-intent mapping unit (704) is configured to identify the portion of the sensor sub-data mapped for various inferences and the selective subunit encryption unit (706) is configured to encrypt or modify the sensor data in such a way that the useful inferences of the plurality of sensor data is made by the plurality of applications and the harmful inferences are not made.

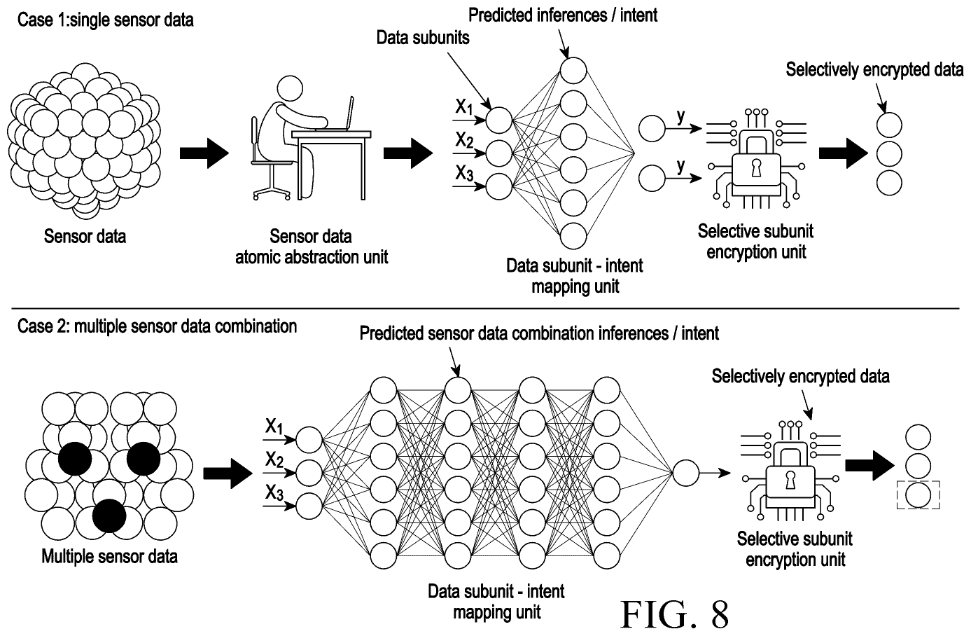

FIG. 8 is a diagram illustrating example types of sensor data combinations in a Sensor Data Modifier (700), according to various embodiments. There may be two types of sensor data combinations such as single sensor data and multiple sensor data combination. In single sensor data, the sensor data of single type is fed to the atomic abstraction unit (702) of the Sensor Data Modifier (700), which atomically abstracts the sensor data into sub-types. Further, the data-subunit-intent mapping unit (704) maps the sensor sub-data to the type of inference. Finally, the selective subunit encryption unit (706), selectively encrypts the sensor data in such a way that the useful inference of the sensor data is made by the application but the harmful inference is not made. Similarly, in case of multiple sensor data combination, multiple sensor data is fed to the atomic abstraction unit (702) of the Sensor Data Modifier (700), which atomically abstracts the multiple sensor data into multiple data sub-types. Further, the data-subunit-intent mapping unit (704) maps the multiple sensor sub-data to the various types of inference. Finally, the selective subunit encryption unit (706), selectively encrypts the sensor data in such a way that the useful inference of the sensor data is made by the application but the harmful inference is not made.

The disclosure may be more clearly understood with reference to the following examples which are given by way of non-limiting example only. The following examples are included to demonstrate certain non-limiting aspects of the disclosure. It should be appreciated by those of skill in the art that the techniques disclosed in the examples which follow represent techniques discovered to function well in the practice of the disclosure. However, those of skilled in the art should, in light of the present disclosure, appreciate that many changes can be made in the specific examples which are disclosed and still obtain a like or similar result without departing from the spirit and scope of the disclosure.

There may be two types of inputs to the Sensor Data Modifier Unit (700) to modify the plurality of sensor data such as inputs from multiple different sensors and inputs from a single sensor.

### Example 1: In Case of Inputs from Multiple Different Sensors to the Sensor Data Modifier

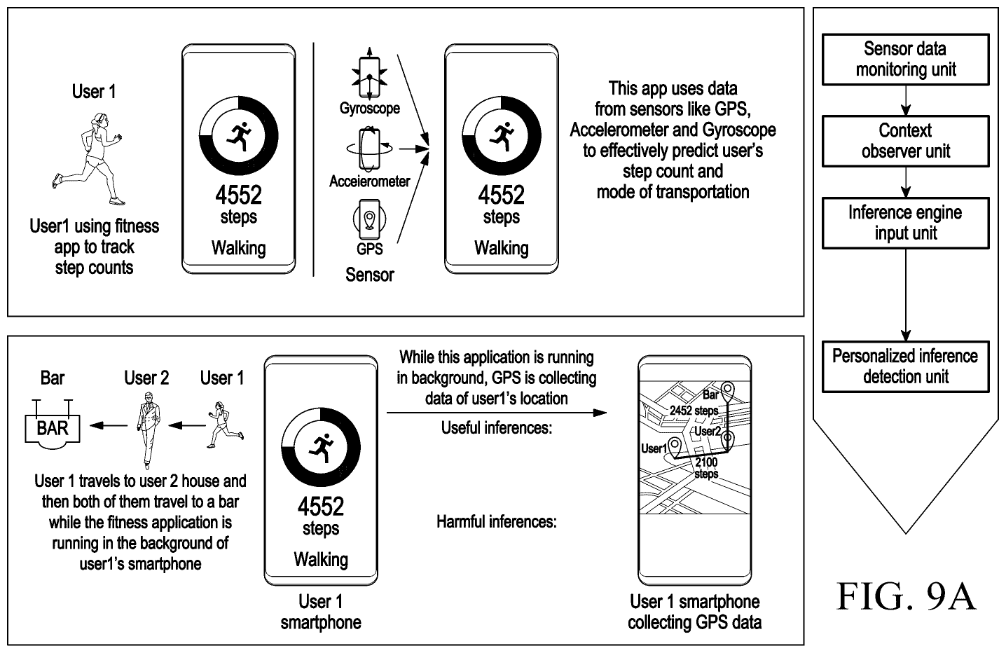

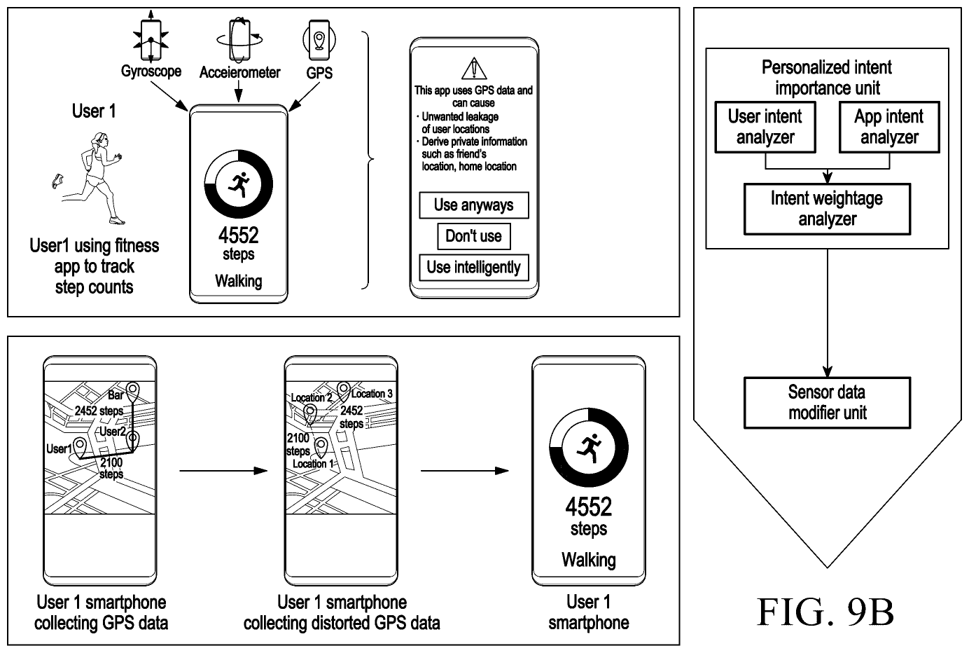

Considering a scenario, where multiple sensor data or plurality of sensor data are used. FIGS. 9A and 9B are diagrams illustrating a screenshot of inputs from multiple different sensors to predict useful inference and harmful inference, according to various embodiments. For instance, a user 1 uses a fitness application to calculate total steps taken and to predict the mode of transport. The fitness application uses data from multiple sensors such as Gyroscope, Accelerometer and GPS to effectively predict user's step count and mode of transportation. In this scenario, the user 1 travels to user 2's house and then both of them travel to a bar, while the fitness application is active in the background of user 1's smartphone. Since, the fitness application is actively running in background, GPS sensor collects data of user 1's location. Accelerometer and Gyroscope readings combined with GPS data predicts effective step count and mode of transport which is the useful inferences, but GPS readings from user 1 is used to derive harmful inferences that the user 1 is unaware of. Although user 2 does not use the GPS, one may easily determine the location of user 2 by the sensor data of the user 1's smartphone running actively in background, GPS is collecting data of user 1's location. Hence, the useful inference includes user 1's step count and mode of transport. Similarly, harmful inference includes user 1 and user 2 location details. Even though, user 2 is not using GPS, one can find out the location details of user 2. Therefore, it can be inferred that both of them, user 1 and user 2 are going to the bar. Moreover, the disclosed system (200) warns the user about the harmful inferences and provide various options to the user such as “use anyways”, “don't use” or “use intelligently”. When the user selects to use fitness application intelligently, a modification in the GPS data to distort the actual information of location is applied. Furthermore, only those sensor data that can cause harmful inferences are modified in such a manner that user's useful inferences are not distorted. In the current scenario, Accelerometer and Gyroscope data are not distorted whereas, only GPS data is encrypted such that the user location information is not shared with the application. Hence, with this data, user's location can be revealed and used for various types of inferences. Since the calculation of step count/transportation mode does not require exact GPS co-ordinates, the disclosed system (200) encrypts the GPS data (e.g., adds fake coordinates) before sharing it with the application, so that the total distance travelled remains the same, but the GPS co-ordinates are changed. Therefore, the application performs user's intended task (step count and mode of transportation) with the same level of accuracy without risking the revelation of the user's location data.

### Example 2: In Case of Inputs from Single Sensor are Provided to the Sensor Data Modifier

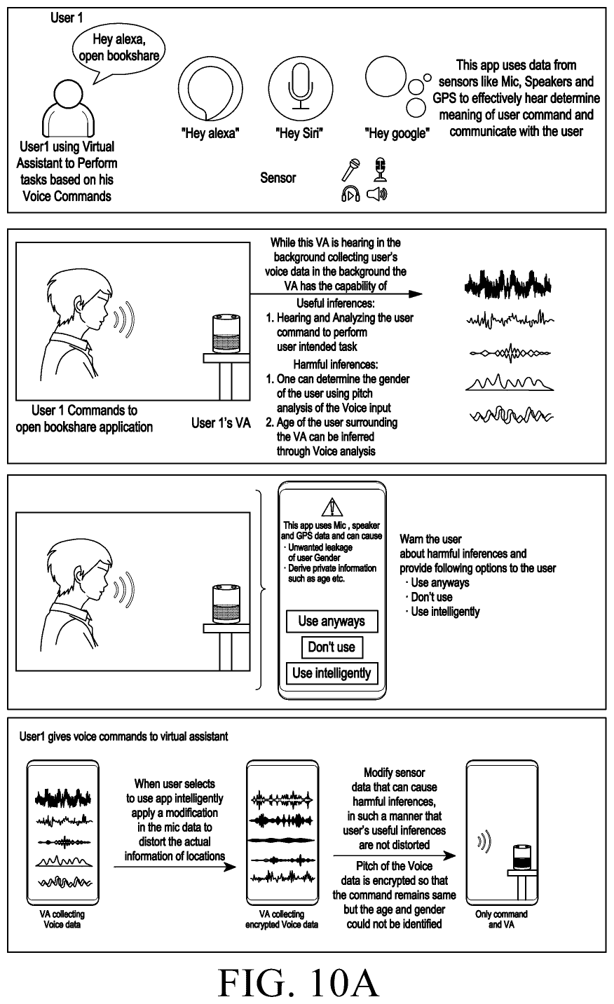

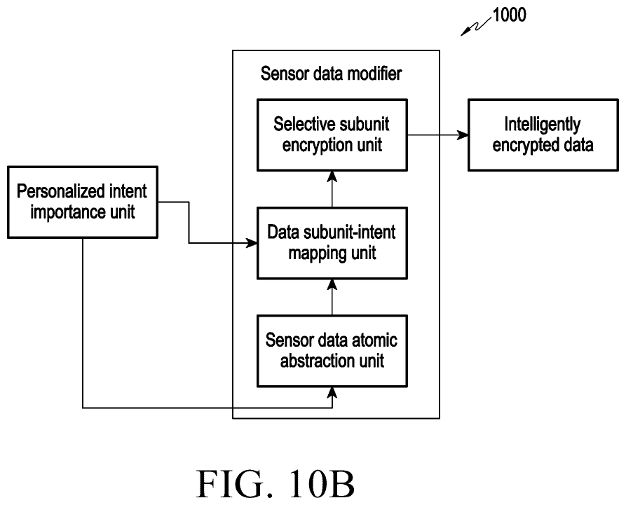

Considering a scenario where a single sensor is used. FIG. 10A is a screenshot illustrating inputs from a single sensor to predict useful inference and harmful inference, according to various embodiments. In this scenario, user 1 uses virtual assistant to perform task based on his/her voice commands such as “Hey Alexa”, “Hey Siri” or “Hey Google”. When the virtual assistant application is running in the background, the virtual assistant is collecting user's data from sensors like Microphone, Speakers and GPS to effectively determine the meaning of user command and communicate with the user. In this scenario, the virtual assistant captures the user's instructions in the background and collects user's voice data. With this data user's gender and age is revealed by analyzing the pitch of the input invoice and used for various types of inferences. In the background, the virtual assistant is capable of predicting useful inferences such as hearing and analyzing the user's command to perform user intended task, and harmful inference such as determination of gender of the user using pitch analysis of the voice input, and also the age of the user surrounding the virtual assistant through voice analysis. Therefore, completing the user task only requires the words and not the pitch of the voice signal. Furthermore, the disclosed system (200) in this scenario, warns the user about harmful inferences and provides various options such as “use anyways”, “don't use” or “use intelligently”. When the user chooses “use intelligently” option of using the application intelligently, the disclosed system (200) applies modification to the microphone data to distort the actual information pertaining to the location. Furthermore, the disclosed system (200) modifies the sensor data that causes harmful inferences, in a manner in which the user's useful inference is not distorted. Therefore, the disclosed system (200) encrypts only the pitch of the voice data (amplify/de-amplify the signal) before sharing it with the application, such that the command remains the same but the pitch is modified. Therefore, the application is able to perform user's intended task or command execution with the same level of accuracy without risking the user gender or age data. Therefore, pitch of the voice data is encrypted, such that the command remains same but the age and gender is not identified.

FIG. 10B is a screenshot illustrating intelligently encrypting sensor data pitch (1000), according to various embodiments. For the user's input voice data, the useful inferences includes hearing and analyzing the user command to perform user intended task; and harmful inferences includes determination of gender of the user using pitch analysis of the voice input and age of the user. Furthermore, for the given voice input and predicted useful inference and harmful inferences, the Sensor Data Modifier intelligently encrypts the data through three different units. The sensor data atomic abstraction unit (702) atomically abstracts the sensor data audio from the microphone. The data-subunit-intent mapping unit (704) identifies the portion of the sensor sub-data mapped for various inferences such as words, pitch and tone. Furthermore, the selective subunit encryption unit (706) encrypts or modifies the sensor data, in such a way that the useful inferences such as words or action command of the sensor data is made used by the application and the harmful inferences such as pitch or gender and tone or age is not made or they are intelligently modified.

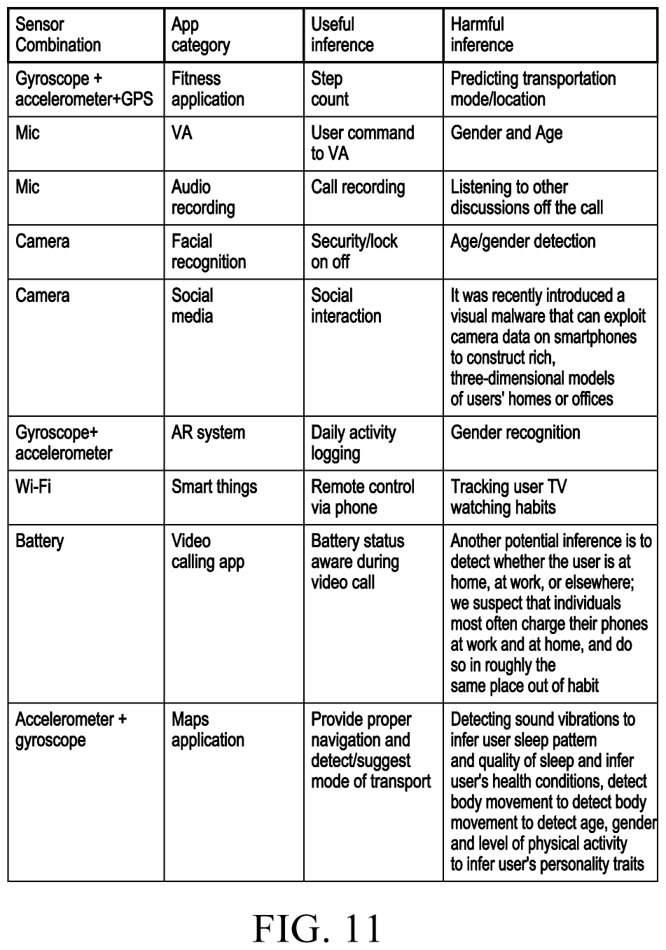

FIG. 11 is a table illustrating various example sensor combinations and useful and harmful inferences, according to various embodiments. For instance, for a combination of Gyroscope+Accelerometer+GPS sensor combination, application category fitness application the useful inference is step count and harmful inference is predicting transportation mode/location. Similarly, for a sensor Wi-Fi, application category smart things the useful inference is remote control via phone and harmful inference is tracking user's TV watching habits.

The disclosure provides an intelligent method and a system for securing sensor data, which learns from the user action on the phone and playstore data and analyses the current context of the user to predict which inferences about the user could be made from the current set of sensor data whose access is provided to the application. Furthermore, the machine learning unit, which includes the Personalized Inference Detection Unit (216) analyses of the risk of the task that the user wishes to perform from an application by measuring the importance parameter of the task in the current context against the risk inferred from all the probable information leak predicted by the previous engine. Therefore, the implementation disclosed in the present disclosure encrypts the plurality of sensor data in such a way that the useful inference of the plurality of sensor data is made by the plurality of application and the harmful inferences is not made.

In addition, the disclosure takes user's personal aspect into consideration to judge on the basis of probable inferred information and about the user, whether sharing the plurality of sensor data is risky or not. The present disclosure not only considers the physical activity of the user, but also includes Artificial Intelligence to predict user's intent with the application and allows the plurality of sensor data with intelligent encryption to be usable only for predicted user's intent. Furthermore, the combination of sensor data requests and warns the user about the consequences/inferences that could possibly be drawn from the data shared. Thus, making user more aware about the consequences of his/her actions. The present disclosure also intelligently encrypts complete/partial data on the basis of user's intended actions from that data. Moreover, the encryption of the plurality of sensor data is personalized depending on the context, wherein same set of plurality of sensor data can be a harmful inference or a useful inference. Hence, the encryption is dynamic in nature.

At least one of the plurality of modules may be implemented through an AI model. A function associated with AI may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning may refer, for example, to, by applying a learning algorithm to a plurality of learning data, a predefined operating rule or AI model of a desired characteristic being made. The learning may be performed in a device itself in which AI according to an embodiment is performed, and/o may be implemented through a separate server/system.

The AI model may include a plurality of neural network layers. Each layer has a plurality of weight values and performs a layer operation through calculation of a previous layer and an operation of a plurality of weights. Examples of neural networks include, but are not limited to, Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), Generative Adversarial Networks (GAN), and deep Q-networks. The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

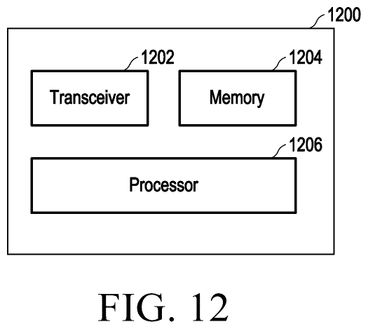

FIG. 12 is a block diagram illustrating an example configuration of an electronic device, according to various embodiments. The system may be implemented through the electronic device (1200). In various embodiments, the electronic device (1200) may be implemented in the hand-held device (204). The electronic device (1200) comprises a processor (e.g., including processing circuitry) (1206), a transceiver (1202) and a memory (1204).

The processor (1206) may be a single processor, may refer to a set of a plurality of processors.

The processor (1206) may include various processing circuitry and communicates with, the memory (1204) and the transceiver (1202). The processor (140) is configured to execute instructions stored in the memory (1204) for securing sensor data. The processor (1206) may include one or a plurality of processors, may be a general purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU). The processor (1206) may be referred to as at least one processor. The processor (1206) may be referred to as a controller.

The processor (1206) may be configured to directly or indirectly execute operations of various units of the present disclosure, including the Sensor Data Monitoring Unit (202), the Context Observer Unit (208), the Inference Engine Input Unit (210), the Personalized Inference Detection Unit (212), the Personalized Intent Importance Unit (216), and the Sensor Data Modifier Unit (218).

The processor 1206 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Storage elements of the memory (1204) storage elements may include magnetic hard discs, optical discs, floppy discs, flash memories, or forms of electrically programmable memories (EPROM) or electrically erasable and programmable (EEPROM) memories. In addition, the memory (1204) may, in various examples, be considered a non-transitory storage medium. The “non-transitory” storage medium is not embodied in a carrier wave or a propagated signal. However, the term “non-transitory” should not be interpreted that the memory (120) is non-movable. The non-transitory storage medium may store data that can, over time, change (e.g., in Random Access Memory (RAM) or cache). The memory (1204) may be an internal storage. In various embodiments, at least a part of the memory (1204) may be an external storage unit of the electronic device (1200), cloud storage, or any other type of external storage.

The memory (1204) may store instructions to be executed by the processor (1206) for the electronic device (1200) performing corresponding operations. The database (206, 214) may be implemented in the memory (1204).

The electronic device (1200) may further comprise a transceiver (1202). The electronic device (1200) or the processor (1206) may communicate with other entities through the transceiver (1202). The transceiver (1202) may include various communication circuitry for communicating with external device via one or networks. The transceiver (1202) may include an electronic circuit specific to a standard that enables wired or wireless communication.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for securing sensor data by an electronic device, the method comprising:
obtaining context information by fetching a plurality of sensor data by a plurality of applications;
mapping the plurality of sensor data to the plurality of applications and storing the mapped plurality of sensor data;
generating pre-processed information based on the context information and the mapped plurality of sensor data;
creating an inference category of the pre-processed information based on the pre-processed information and information from a database; and
predicting at least one useful inference and at least one harmful inference of the plurality of sensor data based on the inference category, the context information and the plurality of sensor data.

2. The method of claim 1, wherein the information from the database includes a known set of the plurality of sensor data required with the inference category.

3. The method of claim 1, further comprising:
encrypting or modifying, at least partially, the plurality of sensor data based on the inference category; and
utilizing and feeding the encrypted or modified plurality of sensor data.

4. The method of claim 3, wherein the encrypting or modifying, at least partially, the plurality of sensor data based on the inference category includes feeding the at least one useful inference and at least one harmful inference, in conjunction with the plurality of sensor data.

5. The method of claim 3, wherein the encrypting or modifying the plurality of sensor data based on the inference category comprises:
abstracting various sub-portions of datatype of the plurality of sensor data;
identifying a portion of the plurality of sensor sub-data mapped for various inferences; and
encrypting or modifying the portion of the plurality of sensor sub-data, such that the useful inferences of the plurality of sensor data are made by the plurality of applications and the harmful inferences are not made.

6. The method of claim 3, wherein the utilizing the encrypted or modified plurality of sensor data includes at least one useful inference of the plurality of sensor data is made and used by the plurality of applications and the at least one harmful inference is not made.

7. The method of claim 3, wherein the encrypted or modified plurality of sensor data is fed into the plurality of applications of a hand-held device; and
wherein the hand-held device includes at least one of a smartphone, mobile phone or a cellular phone.

8. An electronic device configured to secure sensor data, the electronic device comprising:
memory storing instructions; and
at least one processor, comprising processing circuitry, coupled to the memory, wherein the instructions, when executed by the at least one processor, individually and/or collectively, cause the electronic device to:
obtain context information by fetching a plurality of sensor data by a plurality of applications,
map the plurality of sensor data to the plurality of applications and store the mapped plurality of sensor data;
generate pre-processed information based on the context information and the mapped plurality of sensor data;
create an inference category of the pre-processed information based on the pre-processed information and information from a database;
predict at least one useful inference and at least one harmful inference of the plurality of sensor data based on the inference category, the context information and the plurality of sensor data.

9. The electronic device of claim 8, wherein the information from the database includes a known set of the plurality of sensor data required with the inference category.

10. The electronic device of claim 8, wherein the instructions, when executed by the at least one processor, individually and/or collectively, cause the electronic device to:
encrypt or modify, at least partially, the plurality of sensor data based on the inference category; and
utilize and feed the encrypted or modified plurality of sensor data.

11. The electronic device of claim 10, wherein the instructions, when executed by the at least one processor, individually and/or collectively, cause the electronic device to feed the at least one useful inference and at least one harmful inference, in conjunction with the plurality of sensor data for encrypting or modifying the plurality of sensor data based on the inference category.

12. The electronic device of claim 10, wherein for encrypting or modifying the plurality of sensor data based on the inference category, the instructions, when executed by the at least one processor, individually and/or collectively, cause the electronic device to:
abstract various sub-portions of datatype of the plurality of sensor data;
identify a portion of the plurality of sensor sub-data mapped for various inferences; and
encrypt or modify the portion of the plurality of sensor sub-data, such that the useful inferences of the plurality of sensor data are made by the plurality of applications and the harmful inferences are not made.

13. The electronic device of claim 10, wherein the instructions, when executed by the at least one processor, individually and/or collectively, cause the electronic device to encrypt or modify the plurality of sensor data based on the inference category such that the at least one useful inference of the plurality of sensor data is made and used by the plurality of applications and the at least one harmful inference is not made.

14. The electronic device of claim 10, wherein the encrypted or modified plurality of sensor data is fed into the plurality of applications of a hand-held device; and
wherein the hand-held device includes at least one of a smartphone, mobile phone or a cellular phone.

15. A non-transitory computer-readable storage medium storing instructions for securing sensor data, wherein the instructions, when executed by at least one processor of an electronic device, individually and/or collectively, cause the electronic device to perform operations, the operations comprising:
obtaining context information by fetching a plurality of sensor data by a plurality of applications;
mapping the plurality of sensor data to the plurality of applications and storing the mapped plurality of sensor data;
generating pre-processed information based on the context information and the mapped plurality of sensor data;
creating an inference category of the pre-processed information based on the pre-processed information and information from a database; and
predicting at least one useful inference and at least one harmful inference of the plurality of sensor data based on the inference category, the context information and the plurality of sensor data.

16. The non-transitory computer-readable storage medium of claim 15, wherein the operations further comprises:
encrypting or modifying, at least partially, the plurality of sensor data based on the inference category; and
utilizing and feeding the encrypted or modified plurality of sensor data.

17. The non-transitory computer-readable storage medium of claim 16, wherein the encrypting or modifying, at least partially, the plurality of sensor data based on the inference category includes feeding the at least one useful inference and at least one harmful inference, in conjunction with the plurality of sensor data.

18. The non-transitory computer-readable storage medium of claim 16, wherein the encrypting or modifying the plurality of sensor data based on the inference category comprises:
abstracting various sub-portions of datatype of the plurality of sensor data;
identifying a portion of the plurality of sensor sub-data mapped for various inferences; and
encrypting or modifying the portion of the plurality of sensor sub-data, such that the useful inferences of the plurality of sensor data are made by the plurality of applications and the harmful inferences are not made.

19. The non-transitory computer-readable storage medium of claim 16, wherein the utilizing the encrypted or modified plurality of sensor data includes at least one useful inference of the plurality of sensor data is made and used by the plurality of applications and the at least one harmful inference is not made.

20. The non-transitory computer-readable storage medium of claim 16, wherein the encrypted or modified plurality of sensor data is fed into the plurality of applications of a hand-held device; and
wherein the hand-held device includes at least one of a smartphone, mobile phone or a cellular phone.
